(19) United States
(12) Patent Application Publication
(10) Pub. No.: US 2017/0043633 A1
(43) Pub. Date: Feb. 16, 2017

(54) APPARATUS AND METHOD FOR MONITORING THE PRESSURE OF A BICYCLE TIRE

(71) Applicants: LE HOLDINGS (BEIJING) CO., LTD., Beijing (CN); LETV SPORTS CULTURE DEVELOP (BEIJING) CO., LTD., Beijing (CN)

(72) Inventor: Dalong LI, Beijing (CN)

(21) Appl. No.: 15/245,242

(22) Filed: Aug. 24, 2016

Related U.S. Application Data
(63) Continuation of application No. PCT/CN2016/082094, filed on May 13, 2016.

(30) Foreign Application Priority Data
Aug. 11, 2015 (CN) 201510491366.8

(51) Int. Cl. B60C 23/04

(52) U.S. Cl. CPC B60C 23/0496; B60C 23/0447; B60C 23/0488

(57) ABSTRACT

The disclosure provides an apparatus for monitoring the pressure of a bicycle tire, the apparatus including a housing, a pressure sensor, and a communication interface, wherein: the housing is sleeved on an air valve component of the tire, and spirally connected with the air valve component, and a protruding structure is arranged in the housing to extend into the air valve component, and to push away a valve in the air valve component; and a vent hole is arranged on the protruding structure to conduct the air in the tire into the housing; the pressure sensor is arranged in the housing and configured to monitor the pressure of the air in the tire conducted away by the vent hole; and the communication interface is configured to transmit a result of monitoring the pressure to a tire pressure output component for displaying and/or playing.

### CROSS REFERENCE TO RELATED APPLICATIONS

This application is a continuation of International Application No. PCT/CN2016/082094, filed on May 13, 2016, which is based upon and claims priority to Chinese Patent Application No. 201510491366.8, filed on Aug. 11, 2015, the entire contents of which are incorporated herein by reference

### TECHNICAL FIELD

The present disclosure relates to the field of communications, and particularly to an apparatus and method for monitoring the pressure of a bicycle tire.

### BACKGROUND

Although there are a number of transportation means emerging along with the development of technologies, bicycles are still transportation means indispensable for life, working, exercising, and entertainment of people because they are free of a traffic jam, and friendly to our environment.

Tires are so important components of the bicycles that the bicycles can operate normally only if the pressure of the tires remains normal. For example, if the pressure of the tires is too low, then the bicycles will not operate, and if the pressure of the tires is too high, then the tires may suffer from a risk of being exploded. In view of this, there is a need of a method for monitoring the pressure of bicycle tires of so as to secure the bicycles and their riders.

### SUMMARY

Embodiments of the disclosure provide an apparatus and method for monitoring the pressure of a bicycle tire so as to address the problem in the prior art of a hidden risk resulting from no monitor of the pressure of the bicycle tire.

Particular technical solutions according to the embodiments of the disclosure are as follows:

In an aspect, an embodiment of the disclosure provides an apparatus for monitoring the pressure of a bicycle tire, the apparatus including a housing, a pressure sensor, and a communication interface, wherein:

the housing is sleeved on an air valve component of the tire, and spirally connected with the air valve component, and a protruding structure in the housing to extend into the air valve component, and to push away a valve in the air valve component; and a vent hole is arranged on the protruding structure to conduct the air in the tire into the housing;

the pressure sensor is arranged in the housing and configured to monitor the pressure of the air in the tire conducted away by the vent hole; and

the communication interface is configured to transmit a result of monitoring the pressure to a tire pressure output component for displaying and/or playing.

In another aspect, an embodiment of the disclosure provides a method for monitoring the pressure of a bicycle tire, applicable to the apparatus above for monitoring the pressure of a bicycle tire, the method including:

detecting the pressure of the air in a tire at an air valve component of the tire, and obtaining a result of detecting the pressure; and transmitting the result of detecting the pressure to a tire pressure output component for displaying and/or playing.

In the embodiments of the disclosure, the apparatus for monitoring the pressure of a bicycle tire is arranged at the air valve component to monitor the pressure of the bicycle tire and to output the monitor result so that a user can get timely knowledge of the pressure of the bicycle tire, thus securing the user and the bicycle.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed:

FIG. 1 is a first schematic structural diagram of an apparatus for monitoring the pressure of a bicycle tire in accordance with some embodiments;

FIG. 2 is a second schematic structural diagram of the apparatus for monitoring the pressure of a bicycle tire in accordance with some embodiments;

FIG. 3 is a schematic structural diagram of a protruding structure in accordance with some embodiments; and

FIG. 4 is a schematic flow chart of a method for monitoring the pressure of a bicycle tire in accordance with some embodiments.

### DETAILED DESCRIPTION

In order to make the objects, technical solutions, and advantages of the embodiments of the disclosure more apparent, the technical solutions according to the embodiments of the disclosure will be described below clearly and fully with reference to the drawings in the embodiments of the disclosure, and apparently the embodiments described below are only a part but not all of the embodiments of the disclosure. Based upon the embodiments here of the disclosure, all the other embodiments which can occur to those skilled in the art without any inventive effort shall fall into the scope of the disclosure.

### First Embodiment

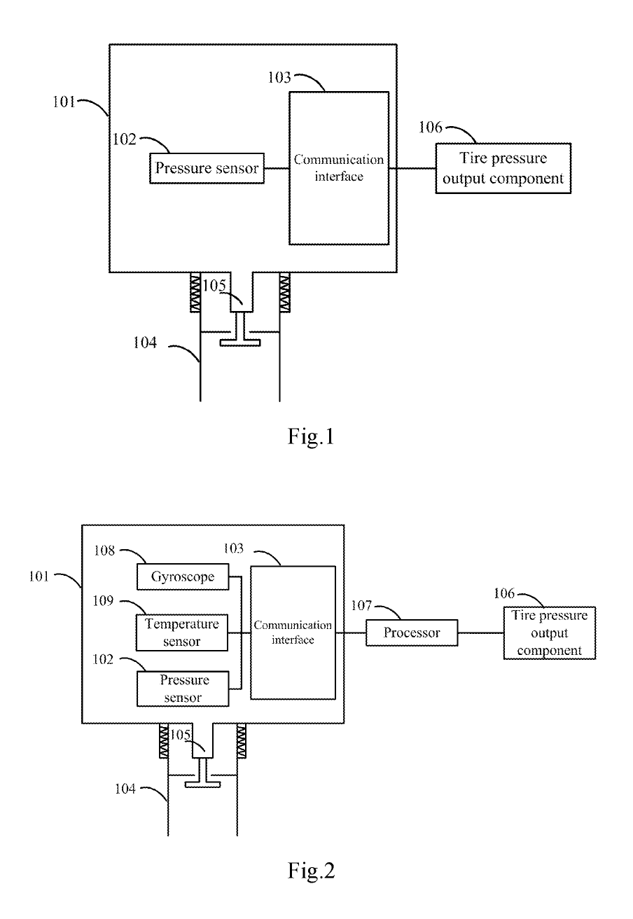

As illustrated in FIG. 1 which is a schematic structural diagram of an apparatus for monitoring the pressure of a bicycle tire according to an embodiment of the disclosure, the apparatus includes a housing 101, a pressure sensor 102, and a communication interface 103, where:

The housing 101 is sleeved on an air valve component 104 of the tire (not illustrated), and spirally connected with the air valve component 104, and a protruding structure 105 is arranged in the housing 101 to extend into the air valve component, and to push away a valve in the air valve component; and a vent hole (not illustrated) is arranged on the protruding structure 105 to conduct the air in the tire into the housing 101;

The pressure sensor 102 is arranged in the housing 101 and configured to monitor the pressure of the air in the tire conducted away by the vent hole; and

The communication interface 103 is configured to transmit a result of monitoring the pressure to a tire pressure output component 106 for displaying and/or playing.

Here in order to ensure the housing 101 to be airtight (that is, the housing 101 has the inside air communicated with the outside air only by the protruding structure 105), FIG. 1 illustrates the communication interface 103 being arranged in the housing 101. In a particular implementation, the communication interface 103 can alternatively be arranged out of the housing 101 as long as the housing 101 is airtight, and the communication interface 103 can be arranged by a user as needed in reality, but the embodiment of the disclosure will not be limited thereto.

Here in an embodiment, the communication interface 103 can be a wired interface, e.g., a USB interface.

Here in an embodiment, the communication interface 103 is capable of wireless communication, for example, the communication interface is Bluetooth-enabled.

Here in an embodiment, the tire pressure output component 106 can be an electronic device arranged out of the housing 101, or can be a smart terminal separate from the apparatus for monitoring the pressure of a bicycle tire, where the smart terminal is a mobile phone, a smart hand ring, etc., for example. If the communication interface is Bluetooth-enabled, then the smart terminal can alternatively be a Bluetooth earphone.

Here the tire pressure output component plays the result of monitor the pressure so that the user can know audibly the tire pressure conveniently while focusing his or her sight onto the condition of a road on which he or she is riding, thus securing the user and the bicycle.

In an embodiment of the disclosure, the pressure of the bicycle tire can be monitored so that the user can get timely knowledge of the state of the tire pressure, thus securing the bicycle being ridden.

The apparatus for monitoring the pressure of a tire according to the embodiment of the disclosure will be described below in details.

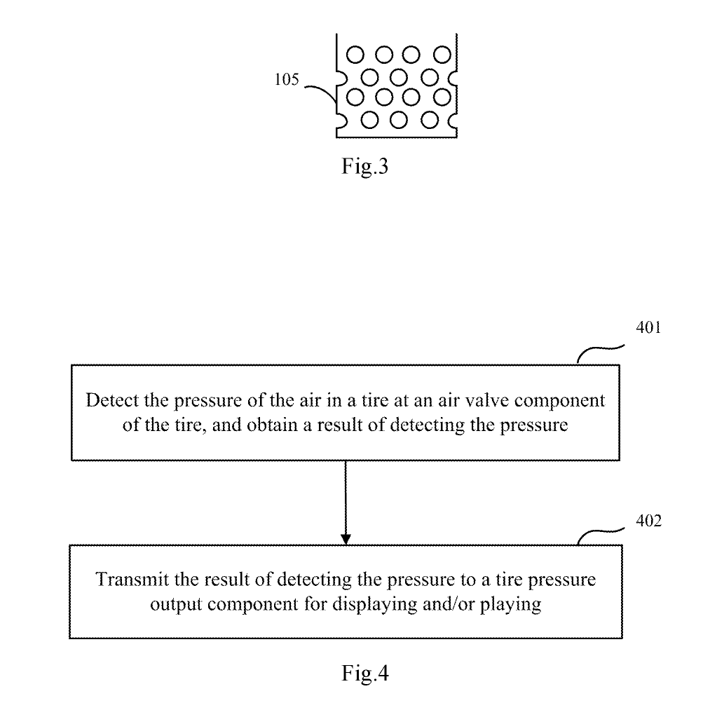

1) Here in an embodiment, FIG. 3 illustrates a schematic structural diagram of the protruding structure 105 on which there are at least one vent hole distributed evenly on the sidewall of the protruding structure.

Here in an embodiment, the shape of the vent hole can be any geometrical shape, e.g., a round, a triangle, a pentagram, etc., and can be preset by a user as needed in reality in a particular implementation, but the embodiment of the disclosure will not be limited thereto.

Here in an embodiment, the sizes of the vent holes may or may not be the same, but the embodiment of the disclosure will not be limited thereto.

2) Here in an embodiment, as illustrated in FIG. 2, in order to make a timely alert if the pressure of the tire is abnormal, so that the user can make a measure to secure the user and the bicycle, the apparatus further includes a processor 107 (which is arranged out of the housing 101 as illustrated in FIG. 2), where:

The processor 107 is configured to obtain the result of monitoring the pressure from the communication interface 103, and to determine whether the result of monitoring the pressure lies in a first preset pressure range; and if the result of monitoring the pressure does not lie in the first preset pressure range, to transmit an alert instruction to the tire pressure output component 106 for an alert.

Here in an embodiment, if the tire pressure output component can play a pressure output result, which means that the tire pressure output component is provided with an audio device, then if the result of monitoring the pressure is above the highest pressure in the first preset pressure range, then a first audio will be played by the audio device, and if the result of monitoring the pressure is below the lowest pressure in the first preset pressure range, then a second audio will be played so that the user can get timely knowledge of the pressure of the tire.

Here in an embodiment, either the processor 107 can be arranged out of the housing 101, or the processor 107 can be arranged in the housing 101.

3) Here in an embodiment, in order to prevent the constantly detecting pressure sensor from wasting power, the apparatus according to the embodiment of the disclosure further includes a gyroscope 108, and FIG. 2 illustrates a schematic structural diagram of the gyroscope 108 being arranged in the housing 101.

The gyro 108 is connected with the communication interface 103, and configured to detect whether the tire is rotating, and to transmit a result of detecting rotation to the processor 107 via the communication interface 103.

The processor 107 is further configured to enable the pressure sensor 102 to operate, if the tire is rotating; and to disable the pressure sensor 102 from operating, if the tire is resting.

Of course, it shall be noted that the gyroscope 108 can alternatively be arranged out of the housing 101 as long as the housing is ensured to be airtight, for example, the gyroscope 108 is arranged on the outer wall of the rim of the bicycle, or on the spoke of the bicycle, but the embodiment of the disclosure will not be limited thereto.

4) Here in an embodiment, the atmospheric pressure varies with temperature, and in order to improve the accuracy of determining whether the pressure of the tire is normal, and thus the accuracy of the alert, the apparatus further includes a temperature sensor 109 as illustrated in FIG. 2, where:

The temperature sensor 109 is arranged in the housing 101, connected with the communication interface 103, and configured to detect the temperature of the air in the tire conducted away by the vent hole, and to transmit a result of detecting the temperature to the processor 107 via the communication interface; and

The processor 107 is configured to search for a second preset pressure range corresponding to the result of detecting the temperature; and to determine whether the result of detecting the pressure lies in the second preset pressure range, found and if the result of detecting the pressure does not lie in the second preset pressure range, to transmit an alarm instruction to the tire pressure output component 106 for an alarm, so that the accuracy of the determination can be improved by further determining from the temperature whether the pressure of the tire is normally, so as to improve the accuracy of the alarm.

Where in a particular implementation, the pressure sensor 102, the communication interface 103, the tire pressure output component 106, the processor 107, the gyroscope 108, and the temperature sensor 109 can be integrated on the same chip.

Of course, in another embodiment, the pressure sensor 102, the communication interface 103, the gyroscope 108, and the temperature sensor 109 can alternatively be arranged on the same chip and arranged in the housing 101, and the processor 107 and the tire pressure output component 106 can be replaced by a smart terminal.

### Second Embodiment

An embodiment of the disclosure further provides a method for monitoring the pressure of a bicycle tire, applicable to the apparatus for monitoring the pressure of a bicycle tire according to the first embodiment above, and FIG. 4 illustrates a schematic flow chart of this method including the following operations:

The operation 401 is to detect the pressure of the air in a tire at an air valve component of the tire, and to obtain a result of detecting the pressure.

The operation 402 is to transmit the result of detecting the pressure to a tire pressure output component for displaying and/or playing.

Here in an embodiment, in order to determine whether the pressure of the tire is normal, and if the pressure of the tire is abnormal, to alert a user in a timely manner, it can be further determined after the operation 104 whether the result of detecting the pressure lies in a first preset pressure range; and if the result of detecting the pressure does not lie in the first preset pressure range, then an alert instruction will be transmitted to the tire pressure output component for an alert, so that the user can get timely knowledge of the pressure state of the tire, and if the pressure of the tire is abnormal, then the user will take a protective measure to thereby secure the user and the bicycle.

Here in an embodiment, since the atmospheric pressure varies with temperature, in order to improve the accuracy of determine whether the pressure of the tire is normal, the following operations can be further performed before the operation 401:

The operation A1 is to detect the temperature of the air in the tire, and to obtain a result of detecting the temperature; and

The operation A2 is to search for a second preset pressure range corresponding to the result of detecting the temperature.

At this time, the operation 401 can be performed particularly by determining whether the result of detecting the pressure lies in the second preset pressure range.

Here in an embodiment, in order to prevent the pressure of the air in the tire at the air valve of the tire from being monitored constantly, before the operation 401, it can be further detected whether the tire is rotating; and if the tire is rotating, then the operation 401 will be performed. If it is determined before the operation 401 that the tire is resting, then the operation 401 will not be performed.

In the embodiments of the disclosure, the pressure of the bicycle tire can be detected so that the user can get timely knowledge of the pressure state of the tire, thus securing the user and the bicycle.

The embodiments of the apparatuses described above are merely exemplary, where the units described as separate components may or may not be physically separate, and the components illustrated as elements may or may not be physical units, that is, they can be collocated or can be distributed onto a number of network elements. A part or all of the modules can be selected as needed in reality for the purpose of the solution according to the embodiments of the disclosure.

Those skilled in the art can clearly appreciate from the foregoing description of the embodiments that the embodiments of the disclosure can be implemented in hardware or in software plus a necessary general hardware platform. Based upon such understanding, the technical solutions above essentially or their parts contributing to the prior art can be embodied in the form of a computer software product which can be stored in a computer readable storage medium, e.g., an ROM/RAM, a magnetic disk, an optical disk, etc., and which includes several instructions to cause a computer device (e.g., a personal computer, a server, a network device, etc.) to perform the method according to the respective embodiments of the disclosure.

Lastly it shall be noted that the respective embodiments above are merely intended to illustrate but not to limit the technical solution of the disclosure; and although the disclosure has been described above in details with reference to the embodiments above, those ordinarily skilled in the art shall appreciate that they can modify the technical solution recited in the respective embodiments above or make equivalent substitutions to a part of the technical features thereof; and these modifications or substitutions to the corresponding technical solution shall also fall into the scope of the disclosure as claimed.

What is claimed is:

1. An apparatus for monitoring the pressure of a bicycle tire, the apparatus comprising a housing, a pressure sensor, and a communication interface, wherein:
the housing is sleeved on an air valve component of the tire, and spirally connected with the air valve component, and a protruding structure is arranged in the housing to extend into the air valve component, and to push away a valve in the air valve component; and a vent hole is arranged on the protruding structure to conduct the air in the tire into the housing;
the pressure sensor is arranged in the housing and configured to monitor the pressure of the air in the tire conducted away by the vent hole; and
the communication interface is configured to transmit a result of monitoring the pressure to a tire pressure output component for displaying and/or playing.

2. The apparatus according to claim 1, wherein the communication interface is capable of wireless communication.

3. The apparatus according to claim 1, wherein the apparatus further comprises a processor configured:
to obtain the result of monitoring the pressure from the communication interface, and to determine whether the result of monitoring the pressure lies in a first preset pressure range; and
if the result of monitoring the pressure does not lie in the first preset pressure range, to transmit an alert instruction to the tire pressure output component for an alert.

4. The apparatus according to claim 3, wherein the apparatus further comprises a gyroscope:
connected with the communication interface, and configured to detect whether the tire is rotating, and to transmit a result of detecting rotation to the processor via the communication interface; and
the processor is further configured to enable the pressure sensor to operate, if the tire is rotating; and to disable the pressure sensor from operating, if the tire is resting.

5. The apparatus according to claim 3, wherein the apparatus further comprises a temperature sensor:
arranged in the housing, connected with the communication interface, and configured to detect the temperature of the air in the tire conducted away by the vent hole, and to transmit a result of detecting the temperature to the processor via the communication interface; and
the processor is configured to search for a second preset pressure range corresponding to the result of detecting the temperature; and to determine whether the result of detecting the pressure lies in the second preset pressure range found, and if the result of detecting the pressure does not lie in the second preset pressure range, to transmit an alarm instruction to the tire pressure output component for an alarm

6. The apparatus according to claims 1, wherein the tire pressure output component is a smart terminal.

7. The apparatus according to claims 2, wherein the tire pressure output component is a smart terminal.

8. The apparatus according to claims 3, wherein the tire pressure output component is a smart terminal.

9. The apparatus according to claims 4, wherein the tire pressure output component is a smart terminal.

10. The apparatus according to claims 5, wherein the tire pressure output component is a smart terminal.

11. A method for monitoring the pressure of a bicycle tire, applicable to the apparatus for monitoring the pressure of a bicycle tire according to claim 1, the method comprising:
detecting the pressure of the air in a tire at an air valve component of the tire, and obtaining a result of detecting the pressure; and
transmitting the result of detecting the pressure to a tire pressure output component for displaying and/or playing.

12. The method according to claim 11, wherein after detecting the pressure of the air in the tire at the air valve component of the tire, and obtaining the result of detecting the pressure, the method further comprises:
determining whether the result of detecting the pressure lies in a first preset pressure range; and
if the result of detecting the pressure does not lie in the first preset pressure range, then transmitting an alert instruction to the tire pressure output component for an alert;

13. The method according to claim 12, wherein before determining whether the result of detecting the pressure lies in the first preset pressure range, the method further comprises:
detecting the temperature of the air in the tire, and obtaining a result of detecting the temperature, and
searching for a second preset pressure range corresponding to the result of detecting the temperature;
determining whether the result of detecting the pressure lies in the first preset pressure range comprises:
determining whether the result of detecting the pressure lies in the second preset pressure range.

14. The method according to claim 11, wherein before detecting the pressure of the air in the tire at the air valve component of the tire, and obtaining the result of detecting the pressure, the method further comprises:
determining whether the tire is rotating; and
if the tire is rotating, then performing the operation of detecting the pressure of the air in the tire at the air valve component of the tire.
